(19) United States
(12) Patent Application Publication
(10) Pub. No.: US 2026/0191214 A1
(43) Pub. Date: Jul. 9, 2026

(54) PROCESSING METHOD FOR PRESERVED FRUITS BY COLD IMPREGNATION

(71) Applicants: Xinjiang Agricultural University, Urumqi City (CN); Xinjiang Sikai Food R&D Center (Co., Ltd.), Changji City (CN)

(72) Inventors: Zuoshan Feng, Urumqi (CN); Haixia Han, Urumqi (CN); Jihua Duan, Changji (CN); Aodi Wang, Urumqi (CN); Yanan Zhang, Urumqi (CN); Yixuan Jiang, Urumqi (CN); Nigeerreyi Yadikaer, Urumqi (CN)

(73) Assignees: Xinjiang Agricultural University, Urumqi City (CN); Xinjiang Sikai Food R&D Center (Co., Ltd.), Changji City (CN)

(21) Appl. No.: 19/444,508

(22) Filed: Jan. 9, 2026

(30) Foreign Application Priority Data
Jan. 9, 2025 (CN) 202510036894.8

(51) Int. Cl. A23B 7/05; A23B 2/10; A23B 7/02; A23B 7/08; A23L 5/41

(52) U.S. Cl. CPC A23B 7/05; A23B 2/103; A23B 7/0215; A23B 7/085; A23L 5/41

(57) ABSTRACT

A processing method for preserved fruits by cold impregnation is provided, belonging to the technical field of preserved fruit preparation. Firstly, washed and cut fruits are appropriately dehydrated to remove part of the water content, thereby enhancing firmness and flexibility of the fruit flesh, avoiding mushiness during the sugar permeation, and reducing sugar consumption as well as the loss of nutritional and flavor substances from the fruits. Following dehydration, low-temperature sugar permeation is conducted, during which the composite of a color-protecting agent and a firming agent are added to the sugar solution, allowing firming and color protection to be completed simultaneously with the sugar permeation of the fruit flesh. This reduces operational steps, improves production efficiency, and avoids the loss of nutrients from fruits caused by repeated rinsing in conventional firming and color-protecting processes.

### CROSS REFERENCE TO RELATED APPLICATION

This patent application claims the benefit and priority of Chinese Patent Application No. 2025100368948, filed with the China National Intellectual Property Administration on Jan. 9, 2025, the disclosure of which is incorporated by reference herein in its entirety as part of the present application.

### TECHNICAL FIELD

The present disclosure provides a processing method for preserved fruits by cold impregnation, belonging to the technical field of preserved fruit preparation.

### BACKGROUND

Preserved fruits are products made mainly from fruits, with or without the addition of food additives and other supplementary materials, through processes such as curing with sugar, honey, or salt (or without curing). Common preserved fruits include preserved apricot, preserved peach, and preserved apple, among others. Preserved fruits represent a food with distinctive ethnic characteristics and have evolved into a type of traditional food. They are not only sweet and sour in taste but also serve as an effective form of processing and storage for fresh fruits.

There are numerous processing techniques for preserved fruits, and based on different preparation methods, they can be classified into various types, such as Beijing-style preserved fruits, Hangzhou-style preserved fruits, and Suzhou-style preserved fruits. However, typical existing processing methods for preserved fruits involve boiling (i.e., sugar boiling), with the most representative being the one-time boiling method and the multiple boiling method. The one-time boiling method involves continuously boiling the fruit raw materials in a sugar solution for nearly one hour. The multiple boiling method requires at least three intermittent heating and boiling cycles for each batch of raw materials. Prolonged or repeated heating leads to the degradation of nutritional and functional components in fruits, resulting in soft and mushy flesh and deterioration of flavor quality. This is particularly detrimental to preserving the original ecological characteristics and flavors of heat-sensitive fruits and melons. Furthermore, the repeated heating steps are cumbersome, not only increasing energy consumption but also resulting in low production efficiency and high costs. Therefore, the development of a simplified processing method for preserved fruits that retains their nutritional value and original ecological flavor quality while reducing energy consumption and improving efficiency has become an important direction for technological breakthrough and innovation in this field.

### SUMMARY

An objective of the present disclosure is to provide a processing method for preserved fruits by cold impregnation. The processing method can reduce the loss of nutritional and flavor substances in fruits, ensure the improvement of preserved fruit quality, and simultaneously achieve simplified processing as well as green and low-carbon processing.

The present disclosure provides a processing method for preserved fruits by cold impregnation, including the following steps:
1) washing and cutting fruits to obtain processed fruits;
2) subjecting the processed fruits to partial dehydration, thereby obtaining partially dehydrated fruits, where a mass of the partially dehydrated fruits is 50% to 80% of a mass of the processed fruits before dehydration;
3) immersing the partially dehydrated fruits in a color-protecting and firming mixed sugar solution and conducting a vacuum treatment to obtain vacuum-treated fruits; where
the color-protecting and firming mixed sugar solution includes a mixed sugar solution, a color-protecting agent, and a firming agent, the mixed sugar solution is prepared by mixing mixed sugar and water in a ratio of 1:(1.5-2) and has a sugar content of 30% to 35%; the mixed sugar in the mixed sugar solution includes malt syrup and granulated sugar, and the malt syrup and the granulated sugar are at a mass ratio of 1:9 to 3:7; a mass of the color-protecting agent is 0.3% to 0.5% of a mass of the mixed sugar solution, and a mass of the firming agent is 0.01% to 0.03% of the mass of the mixed sugar solution;
4) placing the vacuum-treated fruits together with the color-protecting and firming mixed sugar solution into a sugar permeation device to conduct first low-temperature sugar permeation at −2° C. to 0° C., thereby obtaining a mixture of first low-temperature sugar-permeated preserved fruits and the color-protecting and firming mixed sugar solution;
5) supplementing the mixed sugar into the mixture of the first low-temperature sugar-permeated preserved fruits and the color-protecting and firming mixed sugar solution until a mass concentration of the mixed sugar solution in the sugar permeation device reaches 40% to 45%, introducing carbon dioxide into the sugar permeation device, and sealing to conduct second low-temperature sugar permeation at −5° C. to −2° C., thereby obtaining a mixture of second low-temperature sugar-permeated preserved fruits and the color-protecting and firming mixed sugar solution;
6) supplementing the mixed sugar into the mixture of the second low-temperature sugar-permeated preserved fruits and the color-protecting and firming mixed sugar solution until the mass concentration of the mixed sugar solution in the sugar permeation device reaches 55% to 60%, introducing carbon dioxide into the sugar permeation device, and sealing to conduct third low-temperature sugar permeation at −8° C. to −5° C., thereby obtaining a mixture of third low-temperature sugar-permeated preserved fruits and the color-protecting and firming mixed sugar solution; and
7) taking out the preserved fruits from the mixture of the third low-temperature sugar-permeated preserved fruits and the color-protecting and firming mixed sugar solution, draining off the color-protecting and firming mixed sugar solution, and drying to obtain the preserved fruits after the cold impregnation.

Preferably, a process of the partial dehydration includes room-temperature air flow dehydration conducted at 15° C. to 35° C. and hot air dehydration conducted at 30° C. to 50° C.

Preferably, the color-protecting agent includes phytic acid, ascorbic acid, and citric acid at a mass ratio of 3:3:4; and the firming agent is selected from the group consisting of an organic acid calcium salt and an inorganic calcium salt.

Preferably, the partially dehydrated fruits and the color-protecting and firming mixed sugar solution are at a mass ratio of 1:1 to 1:2 in the step 3).

Preferably, the vacuum treatment is conducted under a pressure less than or equal to 15 kPa for 20 min to 30 min in the step 3).

Preferably, the first low-temperature sugar permeation is conducted for 3 d to 15 d in the step 4).

Preferably, the second low-temperature sugar permeation is conducted for 5 d to 30 d in the step 5).

Preferably, the third low-temperature sugar permeation is conducted for 10 d to 300 d in the step 6).

Preferably, the drying is conducted by air flow drying at 15° C. to 50° C. for 12 h to 36 h in the step 7).

Preferably, the fruits are one or more selected from the group consisting of apricot, jujube, apple, crabapple, and melon.

### Beneficial Effects

The present disclosure provides a processing method for preserved fruits by cold impregnation, where the processing method involves subjecting treated fruits to appropriate dehydration, vacuum treatment, three times of low-temperature sugar permeation, and drying sequentially, thereby obtaining the preserved fruits after cold impregnation. In the present disclosure, appropriate dehydration is conducted on washed and cut fruits to enhance their firmness and flexibility, prevent the flesh from becoming soft and mushy during the sugar permeation, reduce the amount of sugar used during sugar permeation, and minimize the loss of nutritional and flavor substances from the fruits. During the low-temperature sugar permeation following dehydration, a color-protecting agent and a firming agent are added to the mixed sugar solution, allowing firming and color protection to be accomplished simultaneously with sugar permeation. This reduces operational steps, improves production efficiency, and avoids the loss of nutrients from fruits caused by repeated soaking and rinsing in conventional firming and color-protecting processes. Most importantly, no heating is applied throughout the entire sugar permeation process for the preserved fruits, and the sugar permeation is entirely conducted at not greater than 0° C. This avoids the destruction of nutritional components and the deterioration of flavor quality caused by heating in conventional preserved fruit processing, thereby not only enhancing the quality of the preserved fruits but also achieving energy saving and consumption reduction. Furthermore, the sugar permeation treatment method, which involves three stages of gradually decreasing temperature and progressively increasing sugar solution concentration, can prevent texture damage caused by flesh freezing due to excessively low cold impregnation temperatures, while also effectively inhibiting microorganisms. This method also serves to store raw materials or semi-finished products for extended periods, thereby prolonging the production cycle for enterprises and improving the utilization rate of processing facilities.

### BRIEF DESCRIPTION OF THE DRAWINGS

To illustrate the examples of the present disclosure or the technical solutions in the prior art more clearly, the accompanying drawings required in the examples will be briefly introduced below.

FIG. 1 shows the color-protecting effects of different color-protecting agents in Experimental Example 1;

FIG. 2 shows the light transmittance detection results of apricot juice after treatment with different color-protecting agents in Experimental Example 1;

FIGS. 3A-3C show the combined effect of firming agent and color-protecting agent on cold-impregnated preserved apricot in Experimental Example 2;

FIGS. 4A-4C show the influence results of partial dehydration on the quality of preserved apricot in Experimental Example 3;

FIG. 5 shows the results of flavonoid and total phenol content in preserved apricot prepared using three treatment methods in Experimental Example 4;

FIG. 6 shows the total ion current chromatograms from gas chromatography-mass spectrometer (GC-MS) analysis of preserved apricot prepared using three treatment methods and fresh apricot fruits in Experimental Example 5;

FIG. 7 shows the types and relative contents of volatile components in preserved apricot prepared using three treatment methods and fresh apricot fruits in Experimental Example 5;

FIG. 8 shows the number of volatile compounds and the types of characteristic volatile components in preserved apricot prepared using three treatment methods and fresh apricot fruits in Experimental Example 5; and

FIG. 9 shows the orthogonal partial least squares discrimination analysis (OPLS-DA) results of preserved apricot prepared using three treatment methods and fresh apricot fruits in Experimental Example 5.

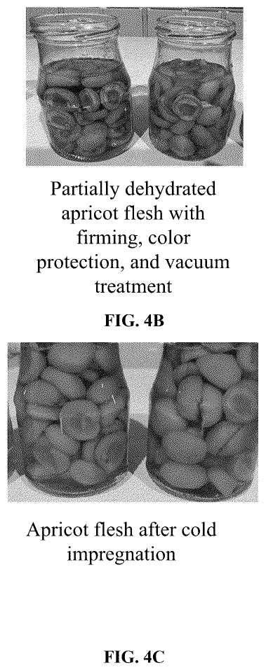

In FIGS. 5-9, HAD indicates Traditional Three-Time Boiling Method, BSW indicates Traditional One-Time Boiling Method, WMD indicates Color-Protecting and Firming Mixed Sugar Solution+Cold Impregnation, and FA indicates fresh apricot.

### DETAILED DESCRIPTION OF THE EMBODIMENTS

The present disclosure provides a processing method for preserved fruits by cold impregnation, including the following steps:
1) washing and cutting fruits to obtain processed fruits;
2) subjecting the processed fruits to partial dehydration, thereby obtaining partially dehydrated fruits, where a mass of the partially dehydrated fruits is 50% to 80% of a mass of the processed fruits before dehydration;
3) immersing the partially dehydrated fruits in a color-protecting and firming mixed sugar solution and conducting a vacuum treatment to obtain vacuum-treated fruits; where
the color-protecting and firming mixed sugar solution includes a mixed sugar solution, a color-protecting agent, and a firming agent, the mixed sugar solution is prepared by mixing mixed sugar and water in a ratio of 1:(1.5-2) and has a sugar content of 30% to 35%; the mixed sugar in the mixed sugar solution includes malt syrup and granulated sugar, and the malt syrup and the granulated sugar are at a mass ratio of 1:9 to 3:7; a mass of the color-protecting agent is 0.3% to 0.5% of a mass of the mixed sugar solution, and a mass of the firming agent is 0.01% to 0.03% of the mass of the mixed sugar solution; where the partially dehydrated fruits and the color-protecting and firming mixed sugar solution are at a mass ratio of 1:1 to 1:2;
4) placing the vacuum-treated fruits together with the color-protecting and firming mixed sugar solution into a sugar permeation device to conduct first low-temperature sugar permeation at −2° C. to 0° C., thereby obtaining a mixture of first low-temperature sugar-permeated preserved fruits and the color-protecting and firming mixed sugar solution;
5) supplementing the mixed sugar into the mixture of the first low-temperature sugar-permeated preserved fruits and the color-protecting and firming mixed sugar solution until a mass concentration of the mixed sugar solution in the sugar permeation device reaches 40% to 45%, introducing carbon dioxide into the sugar permeation device, and sealing to conduct second low-temperature sugar permeation at −5° C. to −2° C., thereby obtaining a mixture of second low-temperature sugar-permeated preserved fruits and the color-protecting and firming mixed sugar solution;
6) supplementing the mixed sugar into the mixture of the second low-temperature sugar-permeated preserved fruits and the color-protecting and firming mixed sugar solution until the mass concentration of the mixed sugar solution in the sugar permeation device reaches 55% to 60%, introducing carbon dioxide into the sugar permeation device, and sealing to conduct third low-temperature sugar permeation at −8° C. to −5° C., thereby obtaining a mixture of third low-temperature sugar-permeated preserved fruits and the color-protecting and firming mixed sugar solution; and
7) taking out the preserved fruits from the mixture of the third low-temperature sugar-permeated preserved fruits and the color-protecting and firming mixed sugar solution, draining off the color-protecting and firming mixed sugar solution, and drying to obtain the preserved fruits after the cold impregnation.

In the present disclosure, as an embodiment, fruits are selected. As another embodiment, the fruits may be, but are not limited to, one or more of apricot, jujube, apple, crabapple, and melon. As an embodiment, the selection method varies for different fruits. For example, in a specific example, when selecting apricots, it is necessary to choose fresh apricots with firm flesh, freestone properties, good color and flavor, and a maturity degree of 7 to 8.5, while discarding rotten and insect-infested apricots. When selecting jujubes, one may choose fresh jujubes, dried jujubes, jujubes with damaged skin, or split-skin jujubes, and discard rotten and insect-infested ones; simultaneously, dried jujubes are rehydrated to ensure that the moisture content of the jujubes used for preparing preserved fruits is 20% to 22%. When selecting melons, one may choose fresh melons with firm flesh, good flavor, red, orange-red, or yellow flesh color, and a maturity degree of 7.5 to 8.5.

In the present disclosure, after the selection, the selected fruits are washed and cut to obtain processed fruits. There is no particular limitation on the washing process, and conventional washing processes in the art may be used. As an embodiment, prior to the cutting, the process may also include peeling and, for fruits containing pits, pitting. There are no specific limitations on the detailed processes, and conventional peeling and pitting steps in the art may be employed.

In the present disclosure, the processed fruits are partially dehydrated to obtain partially dehydrated fruits. A mass of the partially dehydrated fruits is 50% to 80% of a mass of the processed fruits before dehydration. As an embodiment, the mass of the partially dehydrated fruits is 70% to 80% of the mass of the processed fruits before dehydration treatment. As an embodiment, a process of the partial dehydration is room-temperature air flow dehydration conducted at 15° C. to 35° C. or hot air dehydration conducted at 30° C. to 50° C. As another embodiment, the room-temperature air flow dehydration may be conducted at 20° C. to 30° C., and the hot air dehydration may be conducted at 35° C. to 45° C.

The technical advantages of employing the step of dehydration prior to subsequent preparation steps in the present disclosure are as follows: 1) After losing part of their water, the raw fruit materials become firmer in texture and more flexible, making them less prone to softening and mushiness during the sugar permeation process. This helps maintain a better appearance and enables them to better withstand mechanical handling such as agitation and turning during processing. This is particularly suitable for fruits with flesh that is prone to softening, such as apricots, peaches, and melons. Gradient tests have confirmed that when dehydrated to 50% to 80%, especially 70% to 80%, of the original mass of the fruits, the resulting preserved fruits exhibit superior color, plumpness, and textural characteristics. 2) Fruits that have lost part of their water can reduce sugar usage by approximately 30% compared to those that have not been dehydrated. For example, taking 100 kg of fresh fruit with a sugar content of 20% and a 30% water loss before processing into preserved fruit (without considering water exudation from the fresh fruit during sugar permeation): To achieve a 50% sugar content, fresh fruit without dehydration would need to absorb 80 kg of sugar. If 30 kg of water is removed from the fresh fruit before sugar permeation, only 50 kg of sugar needs to be absorbed to achieve a 50% sugar content. This results in a reduction of 30 kg of sugar per 100 kg of raw material, representing a 37.5% reduction compared to the non-dehydrated process. 3) After fruits are immersed in the sugar solution, due to the osmotic pressure of the sugar solution, water is drawn out from the flesh, diluting the sugar solution and lowering its concentration. This also causes the loss of nutritional and flavor substances along with the exuded water. After partial dehydration, the exudation of water when the fruits enter the sugar solution can be effectively reduced, avoiding a significant decrease in sugar solution concentration.

In the present disclosure, the partially dehydrated fruits are immersed in a color-protecting and firming mixed sugar solution and a vacuum treatment is conducted to obtain vacuum-treated fruits.

In the present disclosure, the color-protecting and firming mixed sugar solution includes a mixed sugar solution, a color-protecting agent, and a firming agent. As an embodiment, the mixed sugar solution includes mixed sugar and water, with a mass ratio of 1:(1.5-2); as another embodiment, the mass ratio of mixed sugar to water is 1:1.7. The mixed sugar includes malt syrup and granulated sugar; the mass ratio of malt syrup to granulated sugar is 1:9 to 3:7. Using malt syrup and granulated sugar to prepare the mixed sugar solution has the advantages of reducing sugar content and sweetness, and preventing sugar crystallization and graining in the product. As an embodiment, the color-protecting agent includes phytic acid, ascorbic acid, and citric acid, with a mass ratio of 3:3:4. A mass of the color-protecting agent is 0.3% to 0.5% of a mass of the mixed sugar solution; as an embodiment, the mass of the color-protecting agent is 0.3% to 0.4% of the mass of the mixed sugar solution. As an embodiment, the firming agent is selected from the group consisting of an organic acid calcium salt and an inorganic calcium salt; as another embodiment, the firming agent may be an organic acid calcium salt; as another embodiment, the organic acid calcium salt may be calcium citrate, calcium gluconate, calcium lactate, or calcium acetate; as another embodiment, the organic acid calcium salt may be calcium citrate. A mass of the firming agent is 0.01% to 0.03% of a mass of the mixed sugar solution; as an embodiment, the mass of the firming agent is 0.015% to 0.025% of the mass of the mixed sugar solution. The selection of organic acid calcium salt or inorganic calcium salt as the firming agent not only serves a firming function but also provides a certain calcium supplementation effect, with calcium citrate being a particularly high-quality calcium source. The innovative combination of the color-protecting agent and firming agent with the mixed sugar solution allows the dosage to be controlled at the minimum level required to achieve the color-protecting and firming effects, while fully utilizing the time effect of the long impregnation period. This enables firming and color protection to be completed simultaneously with sugar permeation into the fruit raw materials, eliminating the cumbersome traditional steps of firming and color protection followed by rinsing to remove the hardening and color-protecting agents. This improves production efficiency, reduces production costs, and avoids the loss of nutrients from fruits caused by repeated rinsing. Furthermore, the color-protecting agent used is a sulfur-free color-protecting agent, which is not only highly safe but also possesses certain nutritional value.

In the present disclosure, as an embodiment, the mass ratio of the partially dehydrated fruits to the color-protecting and firming mixed sugar solution is 1:1 to 1:2; and the partially dehydrated fruits are immersed in the color-protecting and firming mixed sugar solution. As an embodiment, the vacuum treatment is conducted under a pressure ≤15 kPa for 20 min to 30 min; as another embodiment, the vacuum treatment is conducted under a pressure ≤10 kPa; as another embodiment, the vacuum treatment is conducted under a pressure ≤5 kPa.

In the present disclosure, the vacuum-treated fruits are placed together with the color-protecting and firming mixed sugar solution into a sugar permeation device to conduct first low-temperature sugar permeation, thereby obtaining a mixture of first low-temperature sugar-permeated preserved fruits and the color-protecting and firming mixed sugar solution. As an embodiment, the sugar permeation device may be a sugar permeation barrel or a sugar permeation tank. The first low-temperature sugar permeation is conducted at −2° C. to 0° C.; the temperature of −2° C. to 0° C. can be achieved by placing devices such as sugar permeation barrels or tanks in a cold storage room, or by using a sugar permeation device with refrigeration, insulation, and temperature control functions, such as a sugar permeation tank equipped with refrigeration, insulation, and temperature control. As an embodiment, the first low-temperature sugar permeation is conducted for 3 d to 15 d; as another embodiment, the first low-temperature sugar permeation is conducted for 7 d to 10 d.

In the present disclosure, the mixed sugar is supplemented into the mixture of the first low-temperature sugar-permeated preserved fruits and the color-protecting and firming mixed sugar solution until a mass concentration of the mixed sugar solution in the sugar permeation device reaches 40% to 45%, carbon dioxide is introduced into the sugar permeation device, and sealing is conducted to conduct second low-temperature sugar permeation, thereby obtaining a mixture of second low-temperature sugar-permeated preserved fruits and the color-protecting and firming mixed sugar solution.

In the present disclosure, as an embodiment, the supplementing the mixed sugar into the mixture of the first low-temperature sugar-permeated preserved fruits and the color-protecting and firming mixed sugar solution until a mass concentration of the mixed sugar solution in the sugar permeation device reaches 40% to 45% may include: a portion of the sugar solution is taken from the mixture of the first low-temperature sugar-permeated fruits and the mixed sugar solution; this portion of the sugar solution is mixed with mixed sugar until the mass concentration of the newly mixed sugar solution reaches 60% to 65%, to obtain a first supplementary sugar solution; the first supplementary sugar solution is then added back into the sugar permeation device, causing the mass concentration of the sugar solution in the sugar permeation device to reach 40% to 45%. As another embodiment, the portion of the sugar solution taken is ½ to ⅓ of the mass of the sugar solution in the mixture of the first low-temperature sugar-permeated fruits and the mixed sugar solution. As another embodiment, the mass ratio of the portion of the sugar solution to the mixed sugar is 2:1. The second low-temperature sugar permeation is conducted at −5° C. to −2° C.; as an embodiment, the second low-temperature sugar permeation is conducted at −4° C. to −3° C. As an embodiment, the second low-temperature sugar permeation is conducted for 5 d to 30 d; as another embodiment, the second low-temperature sugar permeation is conducted for 10 d to 25 d; as another embodiment, the second low-temperature sugar permeation is conducted for 15 d to 20 d. The purpose of introducing carbon dioxide into the sugar permeation device during the second low-temperature sugar permeation is to inhibit potential mold activity at temperatures below 0° C.

In the present disclosure, the mixed sugar is supplemented into the mixture of the second low-temperature sugar-permeated preserved fruits and the color-protecting and firming mixed sugar solution until a mass concentration of the mixed sugar solution in the sugar permeation device reaches 55% to 60%, carbon dioxide is introduced into the sugar permeation device, and sealing is conducted to conduct third low-temperature sugar permeation, thereby obtaining a mixture of third low-temperature sugar-permeated preserved fruits and the color-protecting and firming mixed sugar solution.

In the present disclosure, as an embodiment, the supplementing the mixed sugar into the mixture of the second low-temperature sugar-permeated preserved fruits and the color-protecting and firming mixed sugar solution until a mass concentration of the mixed sugar solution in the sugar permeation device reaches 55% to 60% may include: a portion of the sugar solution is taken from the mixture of the second low-temperature sugar-permeated fruits and the mixed sugar solution; this portion of the sugar solution is mixed with mixed sugar until the mass concentration of the newly mixed sugar solution reaches 60% to 65%, to obtain a second supplementary sugar solution; the second supplementary sugar solution is then added back into the sugar permeation device, causing the mass concentration of the sugar solution in the sugar permeation device to reach 55% to 60%. As an embodiment, the portion of the sugar solution taken is ½ to ⅔ of the mass of the sugar solution in the mixture of the second low-temperature sugar-permeated fruits and the mixed sugar solution. As another embodiment, the mass ratio of the portion of the sugar solution to the mixed sugar is 4:3. The third low-temperature sugar permeation is conducted at −8° C. to −5° C.; as an embodiment, the third low-temperature sugar permeation is conducted at −7° C. to −6° C. As an embodiment, the third low-temperature sugar permeation is conducted for 10 d to 300 d; as another embodiment, the third low-temperature sugar permeation is conducted for 20 d to 200 d; as another embodiment, the third low-temperature sugar permeation is conducted for 25 d to 90 d; as another embodiment, the third low-temperature sugar permeation is conducted for 30 d to 60 d.

In the present disclosure, employing a three-stage low-temperature sugar permeation approach for the sugar permeation process in preserved fruit processing offers the following advantages: 1) Regarding product quality: the entire sugar permeation process is conducted at not greater than 0° C., avoiding the destruction of nutritional and functional components caused by heating, as well as the deterioration of flavor quality induced by heating. This is particularly beneficial for preserving the original ecological flavor of fruits with high heat sensitivity (such as melons, which can develop unpleasant cooked odors when heated). It also prevents fruits from becoming soft and mushy due to repeated heating, thereby enhancing the quality of the preserved fruits. Furthermore, the low-temperature sugar permeation method can inhibit microbial activity, and the employed sugar permeation temperature is not lower than the freezing point of the mixed sugar solution and the fruit flesh, thus avoiding the freezing of the sugar solution and fruits. This especially prevents damage to the tissue texture and softening of the flesh caused by freezing. Additionally, to effectively inhibit microbial activity and extend the storage time of the preserved fruit semi-finished products, carbon dioxide is charged into the sugar permeation device and sealed, based on gradually lowering the sugar permeation temperature and increasing the sugar content. This achieves effective suppression of molds that can still grow slowly at ≤0° C., effectively prolonging the storage of preserved fruit semi-finished products. 2) Regarding energy saving and consumption reduction: compared to existing conventional methods of preparing preserved fruits through heating and boiling, the entire sugar permeation process described herein requires no heating, and consequently, no rapid cooling of heated materials is needed. The required energy consumption is significantly reduced, amounting to only ⅓ to ⅕ of the energy used in heating-based preserved fruit preparation. An even more advantageous aspect is that in northern regions, November onwards provides a natural cold storage environment, requiring minimal refrigeration energy input, and this low temperature can last for 4 to 5 months. This also enables the effective utilization of low-temperature climatic resources. 3) Regarding operational simplicity: in traditional preserved fruit preparation involving heating and boiling, each boiling cycle requires adding the fruit flesh and sugar solution to the heating equipment, and after boiling is complete, the material must be removed to avoid occupying the heating equipment. In the present disclosure, when increasing the sugar solution concentration each time, only a portion of the sugar solution is removed from the mixture of fruits and the mixed sugar solution. After increasing the concentration, the sugar solution is added back to the sugar permeation device without moving the fruit flesh. This not only reduces the operational workload during processing but also avoids damage caused by repeatedly moving the fruit flesh. 4) Regarding extending the production season: the low-temperature sugar permeation operation simultaneously serves to preserve the semi-finished fruit products, effectively extending the enterprise's processing period and increasing production capacity. For instance, apricots have a harvest period of about one month, but traditional preserved fruit processing requires at least 3 to 5 d per batch. With limited factory capacity, only a few batches can be processed before raw materials run out. Although raw material preservation time can be extended currently through salt-curing combined with sun-drying to make salt-cured fruit blanks or through cold storage preservation, the preparation of salt-preserved blanks is cumbersome, nutrients in the fruits are largely lost, and the discharged salt solution during processing causes significant pollution. Cold storage preservation is an option, but generally, fresh fruits can only be refrigerated for about 30 d. Fruits can be frozen for over 1 year, but freezing significantly damages cell and tissue structures, making the flesh extremely prone to softening and mushiness during preserved fruit processing. In the present disclosure, on one hand, the method utilizes appropriate dehydration of raw materials to increase the soluble solid concentration of the fruit raw materials themselves; on the other hand, by soaking in a sugar solution of a certain concentration, sugar permeates into the fruit cell tissues, lowering the freezing point of the flesh and avoiding freezing damage to the flesh tissue at 0° C. As the sugar solution concentration and the sugar content in the flesh gradually increase, their freezing points progressively decrease, allowing the sugar permeation temperature to be gradually lowered. The method also effectively utilizes the gradually decreasing sugar permeation temperature and progressively increasing sugar concentration to strongly inhibit microorganisms, which otherwise could still cause fermentation at temperatures below 0° C. By adopting this combined low-temperature sugar permeation and storage method, enterprises can focus on collecting and storing large quantities of fruit raw materials during the harvest season for cold impregnation sugar permeation and raw material preservation. The subsequent processing steps can be gradually completed after the harvest season, improving facility utilization and extending the production cycle for enterprises.

In the present disclosure, the preserved fruits are taken out from the mixture of the third low-temperature sugar-permeated preserved fruits and the color-protecting and firming mixed sugar solution, the color-protecting and firming mixed sugar solution is drained off, and drying is conducted to obtain the preserved fruits after the cold impregnation. As an embodiment, the fished-out preserved fruits are placed on a perforated sieve tray to drain off excess sugar solution prior to drying. As an embodiment, the drying is air flow drying at 15° C. to 50° C. for 12 h to 36 h. As another embodiment, the air flow drying is room-temperature air flow drying at 15° C. to 35° C. for 18 h to 24 h. The room-temperature air flow drying method fully utilizes the natural conditions in northern regions, especially Xinjiang, where the fruit harvest season occurs during the hot summer and autumn. A significant advantage is the extremely dry air, with relative humidity of 20% to 50%. This dry, hot air serves as an excellent drying medium. Using this dry, hot air to dry preserved fruits requires no energy input, offering advantages in energy saving and consumption reduction. Preserved fruits dried at such low temperatures better retain the characteristic flavor quality of the original fruits.

To further illustrate the present disclosure, the technical solutions provided by the present disclosure are described in detail below in connection with examples and accompanying drawings, but these examples and accompanying drawings shall not be construed as limiting the protection scope of the present disclosure.

### Experimental Example 1

### 1. Materials and Methods

To investigate the color-protecting effects of different color-protecting agents, apricot juice was selected as the experimental material to facilitate the observation of the color-protecting effects of various agents.

Mature apricots were selected and pressed to obtain clarified apricot juice. Sodium bisulfite, sodium sulfite, tea polyphenols, citric acid, cysteine, phytic acid, ascorbic acid, and sodium chloride were separately added to the apricot juice, each at a final concentration of 0.2 g/100 mL. A control sample without any color-protecting agent was also prepared. The samples were left standing for 12 h, after which their color-protecting effects were observed and their light transmittance was measured.

### 2. Experimental Results

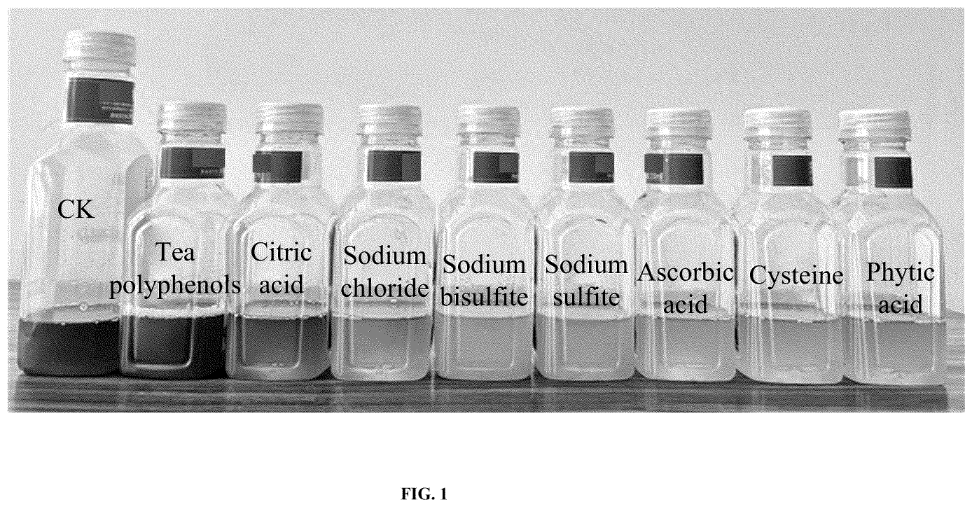

The color-protecting effects of the different agents are shown in FIG. 1. In the figure, arranged from left to right in order of increasing color-protecting effectiveness (from poorest to best), are the control sample and the samples treated with tea polyphenols, citric acid, sodium chloride, sodium bisulfite, sodium sulfite, ascorbic acid, cysteine, and phytic acid.

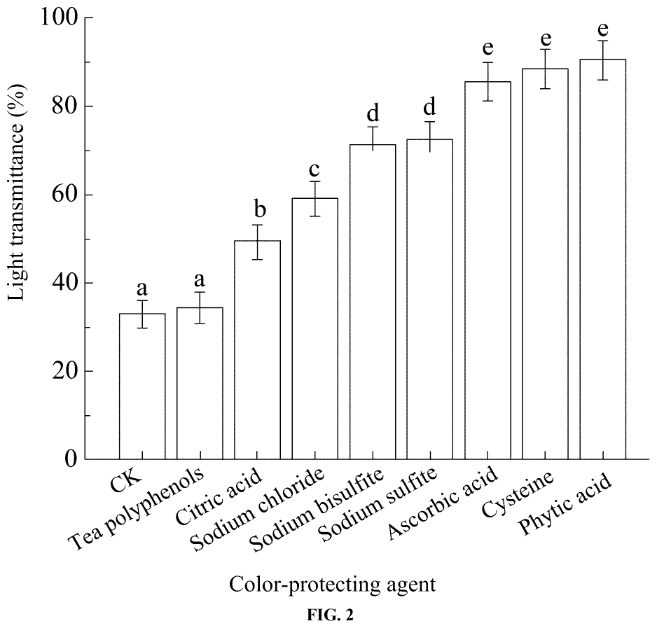

The light transmittance of the apricot juice treated with the color-protecting agents was measured, and the results are shown in FIG. 2. It can be seen that among the various agents, phytic acid, cysteine, and ascorbic acid provided the best color protection. The apricot juice treated with these agents remained original color without significant browning, and there were no significant differences among these three treatments. Sodium bisulfite and sodium sulfite followed next, with the treated apricot juice showing very low browning, and no significant difference was observed between these two. Sodium chloride also exhibited a certain color-protecting effect, but the browning degree of the juice was relatively high and differed from all other treatments. Citric acid showed very poor color protection, differing from all other treatments. However, in practical applications, citric acid is not used for direct color protection but rather for its good synergistic effect with other color-protecting agents. Tea polyphenols showed essentially no color-protecting effect, with a browning degree similar to that of the control, and no significant difference in light transmittance compared to the control.

Therefore, based on comprehensive consideration, a combination of phytic acid, ascorbic acid, and citric acid was selected as the color-protecting agent for the subsequent cold impregnation processing of preserved fruits.

### Experimental Example 2

To investigate the combined effect of firming agent and color-protecting agent on cold-impregnated preserved apricot, the following experiment was conducted:

### 1. Experimental Methods

Fresh apricots with firm flesh, freestone characteristics, good color, and flavor were selected, with a maturity degree of 7 to 8.5. The apricots were cut into halves along the suture line, and the pits were removed. The following treatments were applied separately:

1) Firming agent+Cold impregnation treatment: A mixed sugar solution was added to the apricot flesh. The mixed sugar consisted of malt syrup and granulated sugar with a mass ratio of 3:7. The mixed sugar and water were mixed in a ratio of 1:1.6 to prepare a mixed sugar solution with a sugar content of 35%. The ratio of apricot flesh to mixed sugar solution was 1:1. Calcium citrate was added to the mixed sugar solution as the firming agent at an amount of 0.03% of the mass of the mixed sugar solution.

2) Color-protecting agent+Cold impregnation treatment: A mixed sugar solution was added to the apricot flesh. The mixed sugar consisted of malt syrup and granulated sugar with a mass ratio of 3:7. The mixed sugar and water were mixed in a ratio of 1:1.6 to prepare a mixed sugar solution with a sugar content of 35%. The ratio of apricot flesh to mixed sugar solution was 1:1. A color-protecting agent was added to the mixed sugar solution. The color-protecting agent consisted of phytic acid, ascorbic acid, and citric acid with a mass ratio of 3:3:4. The addition amount of the color-protecting agent was 0.5% of the mass of the mixed sugar solution.

3) Firming agent+Color-protecting agent+Cold impregnation treatment: A mixed sugar solution was added to the apricot flesh. The mixed sugar consisted of malt syrup and granulated sugar with a mass ratio of 3:7. The mixed sugar and water were mixed in a ratio of 1:1.6 to prepare a mixed sugar solution with a sugar content of 35%. The ratio of apricot flesh to mixed sugar solution was 1:1. Calcium citrate was added to the mixed sugar solution as the firming agent at an amount of 0.03% of the mass of the mixed sugar solution. A color-protecting agent was added to the mixed sugar solution. The color-protecting agent consisted of phytic acid, ascorbic acid, and citric acid with a mass ratio of 3:3:4. The addition amount of the color-protecting agent was 0.5% of the mass of the mixed sugar solution.

The apricot flesh from all three treatments was subjected to a vacuum treatment under a pressure of 10 kPa for 30 min. The vacuum-treated apricot flesh and the color-protecting and firming mixed sugar solution were then placed together into a sugar permeation tank. The temperature was controlled at −2° C. to 0° C., and the low-temperature sugar permeation lasted for 10 d.

### 2. Experimental Results

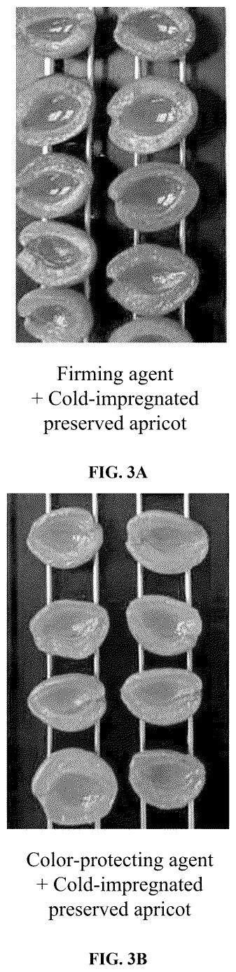

Apricot flesh is a raw material for preserved fruits that is prone to both browning and softening/mushiness, making it relatively difficult to process. The experimental results are shown in FIGS. 3A-3C. It can be seen that for the treatment with the firming agent+cold impregnation, browning of the apricot flesh was relatively severe due to the absence of a color-protecting agent. However, the flesh retained a complete shape and good texture; the apricot flesh maintained a certain firmness without significant softening or mushiness. For the treatment with the color-protecting agent+cold impregnation, the browning degree of the apricot flesh was lower, and the color of the apricot was better preserved. However, the flesh shape was not entirely intact, and the apricot flesh showed some degree of softening and mushiness. For the treatment with the firming agent+color-protecting agent+cold impregnation, the color-protecting effect on the apricot flesh was even better than that of the treatment using the color-protecting agent alone. Furthermore, the flesh shape was intact, the texture was well maintained, the apricot flesh was firm, and no softening or mushiness occurred.

### Experimental Example 3

To investigate the effect of partial dehydration on the quality of preserved apricot, the following experiment was designed. The steps were as follows:

### 1. Experimental Methods

Fresh apricots with firm flesh, freestone characteristics, good color, and flavor were selected, with a maturity degree of 7 to 8.5. The apricots were cut into halves along the suture line, and the pits were removed. The apricot halves were placed on a drying tray with the cavity facing upward and subjected to room-temperature air flow dehydration at 25° C. to 35° C. until the mass of the dehydrated apricot flesh was 50% of the mass of the original raw material.

The mixed sugar consisted of malt syrup and granulated sugar with a mass ratio of 3:7. The mixed sugar and water were mixed in a ratio of 1:1.6 to prepare a mixed sugar solution with a sugar content of 35%. The ratio of apricot flesh to mixed sugar solution was 1:1. Calcium citrate was added to the mixed sugar solution as the firming agent at an amount of 0.03% of the mass of the mixed sugar solution. A color-protecting agent was added to the mixed sugar solution. The color-protecting agent consisted of phytic acid, ascorbic acid, and citric acid with a mass ratio of 3:3:4. The addition amount of the color-protecting agent was 0.5% of the mass of the mixed sugar solution, resulting in the color-protecting and firming mixed sugar solution. The partially dehydrated apricot flesh was immersed in this color-protecting and firming mixed sugar solution and subjected to a vacuum treatment under a pressure of 10 kPa for 30 min. The vacuum-treated apricot flesh and the mixed sugar solution were then placed together into a sugar permeation tank. The temperature was controlled at −2° C. to 0° C., and the low-temperature sugar permeation lasted for 10 d.

### 2. Experimental Results

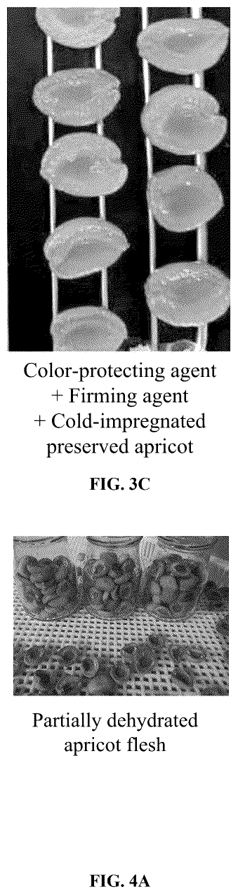

Apricot flesh is highly prone to softening and mushiness during preserved fruit processing. Experiments revealed that the application of appropriate dehydration treatment to apricot flesh prior to sugar permeation can enhance its structural stability, reduce softening and mushiness during subsequent preserved fruit preparation, thereby improving the quality and shelf life of the preserved fruits. The experimental results are shown in FIGS. 4A-4C. In FIGS. 4A-4C, the left image shows the state of apricot flesh after partial dehydration, the middle image shows the state after treatment of the partially dehydrated apricot flesh with firming, color protection, and vacuum treatment, and the right image shows the cold-impregnated apricot flesh. It can be observed that after losing 50% of its weight, the apricot flesh had shrunk. Since no color protection treatment was applied before dehydration, browning was also relatively severe. After soaking in the color-protecting and firming mixed sugar solution, vacuum treatment, and cold impregnation, the quality of the apricot flesh changed significantly. 1) After absorbing sugar and water, the flesh became very plump, and its morphology closely resembled that of fresh apricots. 2) The browning degree improved greatly, and the color became close to that of fresh apricots. 3) Because the apricot flesh lost part of its water before sugar immersion, the flesh became firmer and more flexible. It was less prone to softening and mushiness during the sugar permeation process, maintained a better appearance, and could better withstand mechanical handling such as agitation and turning during processing. 4) In the experiment, dehydration resulted in a water loss of 50% of the fresh weight, which is the limit water loss in the technical solution of this patent. The focus was to investigate the impact on preservation quality when processing apricot flesh in this dehydrated state. The experimental results indicate that even with this degree of water loss, good processing effects could still be achieved under cold impregnation sugar permeation conditions.

### Experimental Example 4

This experiment compared the technical effects of traditional preserved fruit sugar permeation and cold impregnation sugar permeation. The steps were as follows:

### 1. Experimental Methods

(1) Traditional Three-Time Boiling Method of Preserved Apricot: Halved and pitted apricot flesh was color-protected with a 0.1% sulfurous acid solution for 10 min. A mixed sugar solution (35%, prepared using the same method as in Experimental Example 3) was added for the first sugar boiling. The mixture was then sugar-cured at room temperature for 24 h. Mixed sugar was added to increase the sugar solution concentration to 45% for the second sugar boiling, followed by room temperature sugar curing for 24 h. Mixed sugar was added again to increase the concentration to 60% for the third boiling, followed by room temperature sugar curing for 24 h. Finally, the preserved apricot was removed, drained of sugar, and dried using room-temperature air flow at 25° C. to 30° C.

(2) Traditional One-Time Boiling Method of Preserved Apricot: Halved and pitted apricot flesh was color-protected with a 0.1% sulfurous acid solution for 10 min. A mixed sugar solution (35%, prepared using the same method as in Experimental Example 3) was added and brought to a boil. The heat was then reduced, and boiling continued for 45 min, allowing the sugar concentration to gradually increase to 60% through water evaporation. The preserved apricot was removed, drained of sugar, and dried using room-temperature air flow at 25° C.

(3) Color-Protecting and Firming Mixed Sugar Solution+Cold Impregnation of Preserved Apricot: A mixed sugar solution with a sugar content of 35% (prepared using the same method as in Experimental Example 3) was added to halved and pitted apricot flesh. Calcium citrate was added to the mixed sugar solution as the firming agent at an amount of 0.03% of its mass. A color-protecting agent was added to the mixed sugar solution at an amount of 0.5% of its mass. The mixture was subjected to a vacuum treatment under a pressure of 10 kPa for 30 min. The vacuum-treated apricot flesh and the mixed sugar solution were then placed together into a sugar permeation tank. The temperature was controlled at 0° C. for low-temperature sugar permeation for 5 d. The sugar concentration was then increased to 45%, and sugar permeation continued at −2° C. for 7 d. Subsequently, the sugar concentration was increased to 60%, and sugar permeation continued at −5° C. for 10 d. After sugar permeation, the preserved apricot were removed, drained of the sugar solution, and placed evenly on drying trays with the cavity side facing upward. They were then dried using room-temperature air flow at 25° C.

Physicochemical indicators were measured after these three different sugar permeation treatments.

### 2. Experimental Results

The content of specific bioactive components in apricots, namely flavonoids and total phenols, can significantly indicate the impact of processing technology on the nutritional value of preserved fruits. The flavonoid and total phenol contents in preserved apricot obtained by the three experimental methods were measured. The results are shown in FIG. 5. It can be seen that the order of flavonoid and total phenol content from highest to lowest was color-protecting and firming mixed sugar solution+cold impregnation, traditional three-time boiling method, and traditional one-time boiling method, with significant differences (P<0.05) among the treatments. Since flavonoids and total phenols are prone to oxidation and loss during processing, the color-protecting and firming mixed sugar solution+cold impregnation employed low-temperature sugar permeation below 0° C. The low-temperature environment reduced the oxidative destruction of flavonoids and total phenols. In contrast, the traditional one-time boiling method, involving prolonged high-temperature boiling, resulted in more severe losses of flavonoids and total phenols. A comprehensive analysis of these results indicates that the color-protecting and firming mixed sugar solution+cold impregnation can effectively reduce the loss of nutritional and active components during the sugar permeation process. This processing technology helps improve the overall processing quality of preserved fruits.

### Experimental Example 5

The preserved apricot prepared in Experimental Example 4 were used as experimental materials to detect and analyze the volatile components of preserved fruits prepared by various methods, with fresh apricot fruits serving as the control.

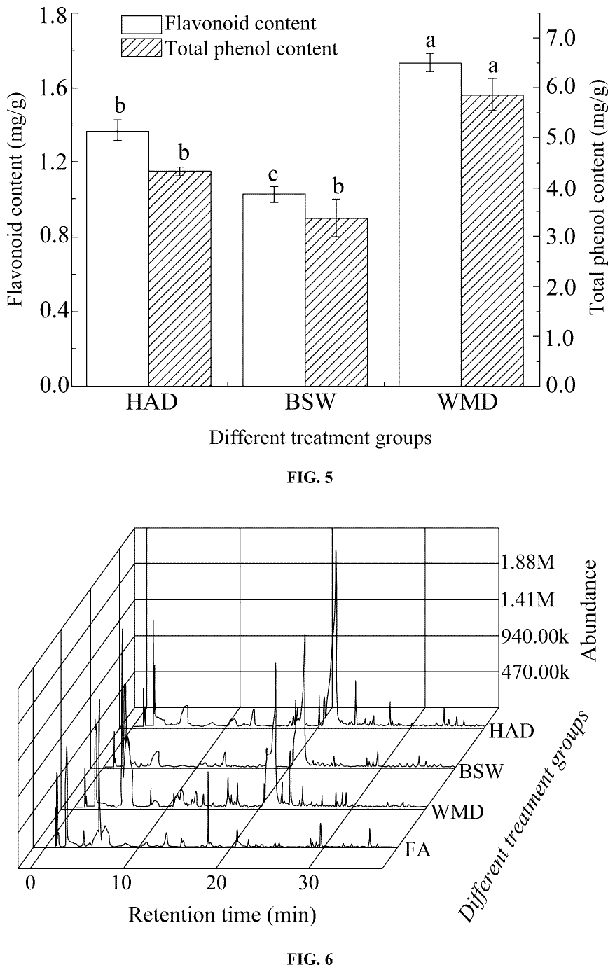

The volatile components in the obtained preserved apricot and the fresh apricot fruits (control) were analyzed using headspace solid-phase microextraction/gas chromatography-mass spectrometry (HS-SPME/GC-MS). The total ion current chromatogram obtained from the analysis (FIG. 6) was used to determine the types and relative contents of volatile substances, as shown in Table 1. FIG. 6 shows that the chromatographic peak areas of samples treated with color-protecting and firming mixed sugar solution+cold impregnation, traditional one-time boiling method, and traditional three-time boiling method exceeded that of the FA (fresh apricot) sample, indicating that the processing enhances the characteristic aroma components of the preserved fruits. Furthermore, under the same analytical conditions, samples obtained by different processing methods exhibited distinct differences in the types and relative contents of aroma compounds.

In fruits and their processed products, alcohol compounds play an important role with their fresh herbal and fruity flavors. Detection of preserved apricot subjected to different treatments revealed a total of 19 alcohol compounds, with their content distribution as follows: color-protecting and firming mixed sugar solution+cold impregnation-treated preserved fruits had the highest alcohol content (14.25%), followed by FA (7.68%), traditional one-time boiling method (5.84%), while traditional three-time boiling method-treated preserved fruits had the lowest alcohol content (2.97%).

Ketone compounds play a crucial role in flavor profiles of preserved fruits. They can neutralize and moderate the taste sensations brought by alcohols and esters, and are one of the common aroma components in fruit-based foods. In the analysis of four groups including 24 samples (6 biological replicates per group), a total of 13 ketone compounds were identified. Specifically, the total ketone compound contents for traditional three-time boiling method, traditional one-time boiling method, color-protecting and firming mixed sugar solution+cold impregnation, and FA were 0.45%, 1.10%, 2.97%, and 1.47%, respectively. In the color-protecting and firming mixed sugar solution+cold impregnation-treated samples, three representative aroma components, L-menthone, piperitone, and piperitenone, were detected, with contents of 0.81%, 1.41%, and 0.16%, respectively. Together, they contributed to a fresh minty and herbal aroma. These ketone compounds help balance the strong odors of ethanol and 1-amino-2-propanol, imparting a fresher and more pleasant flavor experience to the preserved fruits.

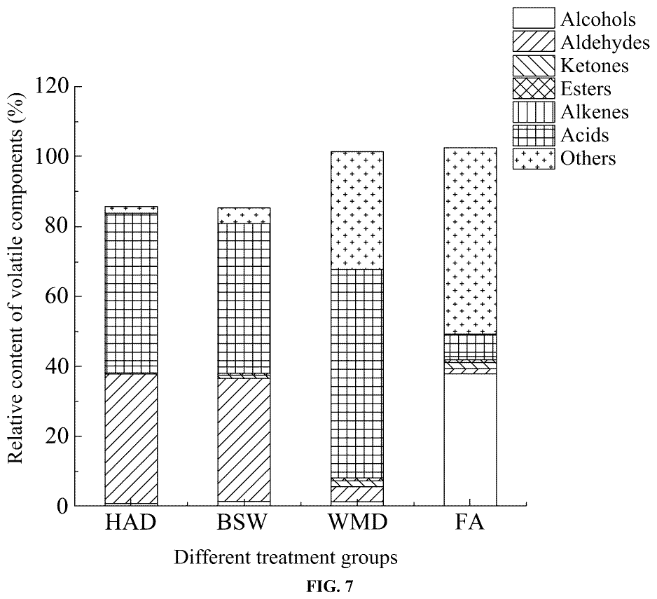

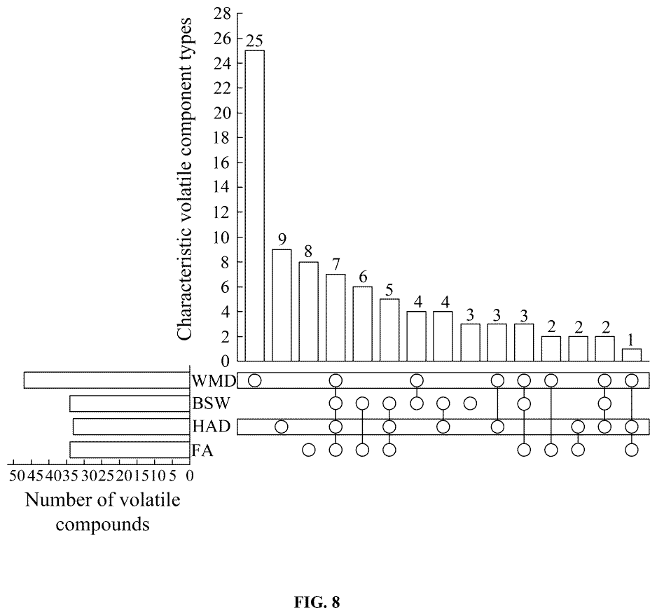

The data in FIG. 7 show that different treatment methods significantly affect the types and relative contents of volatile components in the preserved apricot. As shown in FIG. 7, aldehydes and acids predominated among the volatile components in traditional three-time boiling method- and traditional one-time boiling method-treated preserved fruits; acids and other categories were more prominent in color-protecting and firming mixed sugar solution+cold impregnation-treated preserved fruits; while alcohols and other categories were dominant in fresh fruits. The total relative content of volatile components ranked from high to low as follows: FA, color-protecting and firming mixed sugar solution+cold impregnation, traditional three-time boiling method, traditional one-time boiling method. FIG. 8 further reveals the number of characteristic volatile components unique to each treatment method: color-protecting and firming mixed sugar solution+cold impregnation-treated preserved fruits contained the largest number of characteristic volatile components, up to 26 types; traditional three-time boiling method had 12 unique components; FA had 7; traditional one-time boiling method and FA shared 7 volatile substances; all four treatment methods shared 7 volatile components; and traditional one-time boiling method, FA, and traditional three-time boiling method shared 5 volatile components. These data not only demonstrate the impact of different processing methods on the volatile components of preserved apricot but also reflect the uniqueness of these components under different processing conditions.

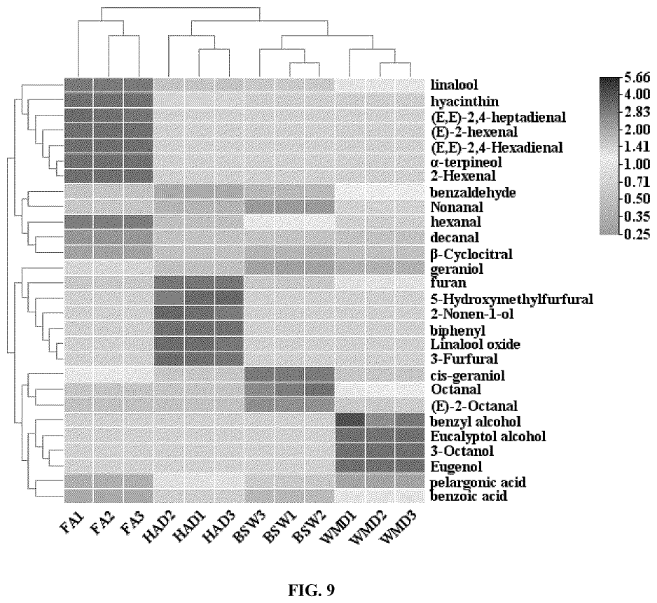

As shown in Table 1, in the color-protecting and firming mixed sugar solution+cold impregnation-treated samples, 13 substances were screened, of which 11 had relative odor activity values (ROAVs) exceeding 0.1. Further analysis identified nonanoic acid, 3-octanol, and benzoic acid as characteristic aroma substances. They possess aromas of coconut and waxy notes, woody, spicy, and minty notes, and cranberry-like aroma, respectively. By combining the ROAV and OPLS-DA methods, along with FIG. 9, this experimental example identified the key differential aroma components among the four types of samples. The key aroma components in traditional three-time boiling method included furan, biphenyl, and 3-furaldehyde; in traditional one-time boiling method, they were linalool, hexanal, and cis-geraniol; in color-protecting and firming mixed sugar solution+cold impregnation, they were hexanal, linalool, and 3-octanol. Linalool and (E,E)-2,4-hexadienal were the characteristic aroma components in the FA treatment.

TABLE 1
ROAV values of volatile components in preserved apricot and fresh apricots under different
treatment conditions

| | | | ROAV | | | |
|---|---|---|---|---|---|---|
| | | | Traditional | Traditional | Color-protecting | |
| | | Threh | three-time | one-time | and firming mixed | |
| Compound | Aroma | old | boiling | boiling | sugar solution + | |
| name | characteristic | (μg/kg) | method | method | cold impregnation | FA |
| Linalool | Strong | 6.00 | 0.32 | — | — | — |
| oxide | woody, | | | | | |
| | floral | | | | | |
| | aroma | | | | | |
| | with | | | | | |
| | camphora- | | | | | |
| | ceous | | | | | |
| | notes; | | | | | |
| | cis-isomer | | | | | |
| | aroma | | | | | |
| | superior | | | | | |
| | to trans. | | | | | |
| Linalool | Lilac, | 6.00 | 0.98 | 1.47 | 4.76 | 34.23 |
| | rose | | | | | |
| | aroma | | | | | |
| 2-Nonen-1- | Sweet | 40 | 0.17 | — | — | — |
| ol | fatty | | | | | |
| | odor | | | | | |
| Geraniol | Sweet | 7.50 | 3.08 | 4.20 | — | 0.92 |
| | floral- | | | | | |
| | fruity | | | | | |
| | odor | | | | | |
| Benzyl | Mild | 100.00 | — | <0.10 | <0.10 | — |
| alcohol | aromatic | | | | | |
| | odor | | | | | |
| cis- | Natural | 7.90 | — | 1.37 | — | 0.37 |
| Geraniol | neroli | | | | | |
| | sweet | | | | | |
| | odor | | | | | |
| 3-Octanol | Waxy | 0.10 | — | — | 14.77 | — |
| | aroma, | | | | | |
| | with | | | | | |
| | woody, | | | | | |
| | spicy, | | | | | |
| | and | | | | | |
| | minty | | | | | |
| | nuances. | | | | | |
| Eucalyptol | Camphor- | 2.00 | — | — | 0.70 | — |
| | like | | | | | |
| | pungent | | | | | |
| | odor, | | | | | |
| | with | | | | | |
| | eucalyptus | | | | | |
| | and | | | | | |
| | spike | | | | | |
| | lavender | | | | | |
| | notes. | | | | | |
| Ethanol | Alcoholic | 14300.00 | — | — | — | <0.10 |
| | odor | | | | | |
| | and | | | | | |
| | pungent | | | | | |
| | spicy | | | | | |
| | taste. | | | | | |
| α- | Charac- | 2.43 | — | — | — | 9.93 |
| Terpineol | teristic | | | | | |
| | clove-like | | | | | |
| | aroma | | | | | |
| 5-Hydroxy- | Cardboard, | 1100.00 | 0.17 | — | — | — |
| methyl- | carton | | | | | |
| furfural | odor | | | | | |
| 3-Furalde- | Odor | 700.00 | 0.33 | — | — | — |
| hyde | similar | | | | | |
| | to bitter | | | | | |
| | almond/ | | | | | |
| | almond | | | | | |
| Benzalde- | Bitter | 50.00 | <0.10 | 1.59 | 1.01 | 1.46 |
| hyde | almond | | | | | |
| | odor | | | | | |
| 5-Methyl- | Spicy, | 1110.00 | <0.10 | — | — | — |
| 2-furalde- | sweet, | | | | | |
| hyde | caramel- | | | | | |
| | like | | | | | |
| | odor | | | | | |
| Octanal | Strong | 56.00 | <0.10 | 0.14 | <0.1 | — |
| | fruity | | | | | |
| | odor | | | | | |
| Nonanal | Strong | 15.00 | 0.65 | 5.05 | 1.51 | 3.54 |
| | oily | | | | | |
| | odor, | | | | | |
| | dilution | | | | | |
| | yields | | | | | |
| | rose and | | | | | |
| | citrus-like | | | | | |
| | aroma. | | | | | |
| Decanal | Aromatic | 7.60 | — | 1.36 | — | 2.13 |
| | odor | | | | | |
| (E)-2- | Herbal, | 2.30 | — | 1.07 | 0.64 | — |
| Octenal | banana | | | | | |
| | odor | | | | | |
| β- | Tropical | 5.00 | — | 3.74 | — | 4.82 |
| Cyclocitral | saffron | | | | | |
| | odor | | | | | |
| 2-Hexenal | Special | 110.00 | — | — | — | 5.54 |
| | green | | | | | |
| | leaf | | | | | |
| | aroma | | | | | |
| (E)-2- | Pleasant | 88.50 | — | — | — | 7.64 |
| Hexenal | green | | | | | |
| | leafy | | | | | |
| | and | | | | | |
| | fruity | | | | | |
| | aroma in | | | | | |
| | trace | | | | | |
| | amounts. | | | | | |
| (E,E)-2,4- | Citrus | 1.80 | — | — | — | 46.52 |
| Hexa- | odor | | | | | |
| dienal | | | | | | |
| (E,E)-2,4- | Slightly | 5.70 | — | — | — | 0.77 |
| Hepta- | cinnamon- | | | | | |
| dienal | like | | | | | |
| | odor | | | | | |
| Nonanoic | Mild | 1.50 | 2.29 | 5.25 | 8.21 | — |
| acid | fatty and | | | | | |
| | coconut | | | | | |
| | aroma | | | | | |
| Benzoic | Cranberry- | 340 | 6.69 | 8.67 | 5.12 | <0.10 |
| acid | like | | | | | |
| | odor | | | | | |
| Furan | Mild | 8.00 | 100.18 | — | 2.64 | — |
| | odor | | | | | |

From the above results, it can be concluded that the color-protecting and firming mixed sugar solution+cold impregnation-treated preserved apricot samples (i.e., those prepared according to the method of the present disclosure) significantly reduced the loss of nutritional and active components during the sugar permeation process, thereby markedly improving the overall quality of the preserved fruits. In the color-protecting and firming mixed sugar solution+cold impregnation-treated preserved fruits, the highest number of characteristic volatile components was detected, totaling 26 types, among which the content of alcohol compounds was the highest, reaching 14.25%. Furthermore, these preserved fruits were rich in representative aroma components such as L-menthone, piperitone, and piperitenone. These components worked together to impart a fresh herbal and fruity aroma to the preserved fruits, offering a more refreshing and pleasant taste experience. It is particularly noteworthy that the key aroma components in color-protecting and firming mixed sugar solution+cold impregnation-treated preserved fruits included hexanal, linalool, and 3-octanol. These components showed clear distinctions compared to preserved fruits from other treatment groups, exhibiting superior aroma characteristics. These findings not only confirm the advantage of color-protecting and firming mixed sugar solution+cold impregnation in preserving the flavor of preserved apricot but also highlight its potential in enhancing the processing quality of preserved fruits.

Based on the aforementioned conclusions, it is evident that the processing method for preserved fruits by cold impregnation in the present disclosure can reduce the loss of nutritional components in preserved fruits and improve their aroma components and quality compared to conventional preparation methods. Therefore, the method in the present disclosure can also be used to prepare various types of preserved fruits, as illustrated in Examples 1 to 3.

### Example 1

A processing method for preserved apricot by cold impregnation included the following steps:

### (1) Pretreatment of Fresh Apricots

Fresh apricots of a variety with firm flesh, freestone characteristics, good color, and flavor were selected, with a maturity degree of 7 to 8.5. Rotten, insect-infested, or other raw materials not meeting processing requirements were discarded. The apricots were cut into halves along the suture line, and the pits were removed.

### (2) Dehydration

The apricot halves were placed on baking trays or drying trays with the cavity facing upward and subjected to room-temperature air flow dehydration at 30° C. until the mass of the dehydrated apricot flesh was reduced to 70% of the mass of the original raw material.

### (3) Mixed Sugar Solution and Color-Protecting and Firming Mixed Sugar Solution Formulas

Mixed Sugar Solution: The mixed sugar consisted of malt syrup and granulated sugar with a mass ratio of 3:7. The mixed sugar and water were mixed in a ratio of 1:1.6 to prepare a mixed sugar solution with a sugar content of 33% (calculated by mass fraction).

Color-Protecting and Firming Mixed Sugar Solution: Based on the aforementioned mixed sugar solution, a color-protecting agent and a firming agent were added. The color-protecting agent consisted of phytic acid, ascorbic acid, and citric acid with a mass ratio of 3:3:4. The addition amount of the color-protecting agent was 0.5% of the mass of the mixed sugar solution. The firming agent was calcium citrate, added at an amount of 0.03% of the mass of the mixed sugar solution.

### (4) Vacuum Treatment

The pretreated apricot flesh was placed into a vacuum tank. The color-protecting and firming mixed sugar solution from step (3) was added, with a mass ratio of apricot flesh to sugar solution of 1:2. The apricot flesh was pressed down to be completely submerged in the sugar solution. A vacuum treatment was then performed under a pressure of ≤5 kPa for 20 min.

### (5) First Low-Temperature Sugar Permeation

The vacuum-treated apricot flesh together with the color-protecting and firming mixed sugar solution was transferred into a sugar permeation tank, which was then placed in a cold storage room. The temperature of the material inside the sugar permeation tank was controlled at −1° C. The first low-temperature sugar permeation lasted for 10 d.

### (6) Second Low-Temperature Sugar Permeation

A portion of the sugar solution was taken out from the sugar permeation tank (the amount taken was ½ of the total mass of the sugar solution in the tank). Newly prepared mixed sugar (malt syrup: granulated sugar=3:7) was added to this portion. No color-protecting agent or firming agent needed to be added to this mixed sugar. The mass ratio of the portion of sugar solution to the mixed sugar was 2:1. They were stirred until dissolved, resulting in a newly mixed sugar solution with a mass concentration of 60%. This newly prepared sugar solution was added back into the sugar permeation tank. Gentle agitation was applied to distribute the concentration evenly, achieving a mass concentration of 43% for the sugar solution in the tank. The temperature of the material inside the tank was then lowered to −3° C. Carbon dioxide was charged into the sugar permeation tank, which was then sealed for the second low-temperature sugar permeation, lasting for 20 d.

### (7) Third Low-Temperature Sugar Permeation

A portion of the sugar solution was taken out from the sugar permeation tank (the amount taken was ⅔ of the total mass of the sugar solution in the tank). Newly prepared mixed sugar (malt syrup: granulated sugar=3:7) was added to this portion. No color-protecting agent or firming agent needed to be added to this mixed sugar solution. The mass ratio of the portion of sugar solution to the mixed sugar was 4:3. They were stirred until dissolved, achieving a sugar solution concentration of 65%. The prepared mixed sugar solution was then added back into the sugar permeation tank. Gentle agitation was applied to distribute the concentration evenly, achieving a mass concentration of 60% for the sugar solution in the tank. The temperature of the material inside the tank was lowered to −5° C. to −8° C. Carbon dioxide was charged into the sugar permeation tank, which was then sealed. The third low-temperature sugar permeation lasted for 60 d.

### (8) Drying

The preserved apricot were removed from the sugar solution and placed on perforated sieve trays to drain off excess sugar solution. The apricot halves were arranged on baking trays with the cavity facing upward and dried using air flow at 25° C. for 24 h until the moisture content reached 17% to 18%, resulting in cold-impregnated preserved apricot.

### Example 2

A processing method for preserved red jujube by cold impregnation included the following steps:

### (1) Raw Material and Pretreatment

Red jujubes harvested in the current year were selected. Rotten, insect-infested, or other raw materials not meeting processing requirements were discarded. The red jujubes were washed, and after dehydration and drying, their moisture content was adjusted to approximately 20% to 22%. The pits were then removed using a jujube pitting machine.

### (2) Mixed Sugar Solution Formula

The mixed sugar consisted of malt syrup and granulated sugar with a mass ratio of 1:9. The mixed sugar and water were mixed in a ratio of 1:1.8 to prepare a mixed sugar solution with a sugar concentration of 36% by mass fraction.

### (3) Vacuum Treatment

The pretreated red jujube flesh was placed into a vacuum tank. The mixed sugar solution was added, with a mass ratio of red jujube flesh to sugar solution of 1:1. The red jujube flesh was pressed down to be completely submerged in the sugar solution. A vacuum treatment was then performed under a pressure of ≤15 kPa for 25 min.

### (4) First Low-Temperature Sugar Permeation

The vacuum-treated red jujube flesh together with the mixed sugar solution was transferred into a sugar permeation barrel, which was then placed in a cold storage room. The temperature of the material inside the sugar permeation barrel was controlled at −2° C. The first low-temperature sugar permeation lasted for 5 d.

### (5) Second Low-Temperature Sugar Permeation

A portion of the sugar solution was taken out from the sugar permeation barrel (the amount taken was ⅓ of the total mass of the sugar solution in the barrel). Newly prepared mixed sugar (malt syrup: granulated sugar=1:9) was added to this portion. The mass ratio of the portion of sugar solution to the mixed sugar was 2:1. They were stirred until dissolved, achieving a sugar solution concentration of 55%. This newly prepared sugar solution was added back into the sugar permeation barrel. Gentle agitation was applied to distribute the concentration evenly, achieving a mass concentration of 45% for the sugar solution in the barrel. The temperature of the material inside the barrel was then lowered to −5° C. Carbon dioxide was charged into the sugar permeation barrel, which was then sealed for the second low-temperature sugar permeation, lasting for 10 d.

### (6) Third Low-Temperature Sugar Permeation

A portion of the sugar solution was taken out from the sugar permeation barrel (the amount taken was ½ of the total mass of the sugar solution in the barrel). Newly prepared mixed sugar (malt syrup: granulated sugar=1:9) was added to this portion. The mass ratio of the portion of sugar solution to the mixed sugar was 2:1. They were stirred until dissolved, achieving a sugar solution concentration of 65%. The prepared mixed sugar solution was then added back into the sugar permeation barrel. Gentle agitation was applied to distribute the concentration evenly, achieving a mass concentration of 58% for the sugar solution in the barrel. The temperature of the material inside the barrel was lowered to −8° C. Carbon dioxide was charged into the sugar permeation barrel, which was then sealed. The third low-temperature sugar permeation lasted for 20 d.

### (7) Drying

The preserved red jujube were removed from the sugar solution and placed on perforated sieve trays to drain off excess sugar solution. They were then arranged on baking trays and dried using air flow at 50° C. for 15 h until the moisture content reached 17%, resulting in cold-impregnated preserved red jujubes.

### Example 3

A processing method for preserved melon by cold impregnation included the following steps:

### (1) Melon Pretreatment

Fresh melons of a variety with firm flesh, good flavor, and red, orange-red, or yellow flesh color were selected, with a maturity degree of 7.5 to 8.5. Raw materials not meeting processing requirements were discarded. The melons were peeled and deseeded. Each melon was first cut lengthwise into four even strips, and then each strip was cut crosswise into slices approximately 1 cm thick.

### (2) Dehydration

The sliced melon pieces were placed on baking trays or drying trays and subjected to room-temperature air flow dehydration at 25° C. until the mass of the melon flesh was reduced to 85% of the mass of the original raw material.

### (3) Mixed Sugar Solution and Color-Protecting and Firming Mixed Sugar Solution Formulas

Mixed Sugar Solution: The mixed sugar consisted of malt syrup and granulated sugar with a mass ratio of 2:8. The mixed sugar and water were mixed in a ratio of 1:1.7 to prepare a mixed sugar solution with a sugar content of 34% (calculated by mass fraction).

Color-Protecting and Firming Mixed Sugar Solution: Based on the aforementioned mixed sugar solution, a color-protecting agent and a firming agent were added. The color-protecting agent consisted of phytic acid, ascorbic acid, and citric acid with a mass ratio of 3:3:4. The addition amount of the color-protecting agent was 0.3% of the mass of the mixed sugar solution. The firming agent was calcium gluconate, added at an amount of 0.02% of the mass of the mixed sugar solution.

### (4) Vacuum Treatment

The pretreated melon flesh was placed into a vacuum tank. The color-protecting and firming mixed sugar solution was added, with a mass ratio of melon flesh to the sugar solution of 1:1.7. The melon flesh was pressed down to be completely submerged in the sugar solution. A vacuum treatment was then performed under a pressure of ≤10 kPa for 30 min.

### (5) First Low-Temperature Sugar Permeation

The vacuum-treated melon flesh together with the color-protecting and firming mixed sugar solution was transferred into a sugar permeation tank capable of refrigeration, insulation, and temperature control (stainless steel tank with a capacity of 0.2 tons to 5 tons). The temperature of the material inside the sugar permeation tank was controlled at 0° C. to −1° C. The first low-temperature sugar permeation lasted for 15 d.

### (6) Second Low-Temperature Sugar Permeation

A portion of the sugar solution was taken out from the sugar permeation tank (the amount taken was ⅔ of the total mass of the sugar solution in the tank). Newly prepared mixed sugar (malt syrup: granulated sugar=2:8) was added to this portion. No color-protecting agent or firming agent needed to be added to this mixed sugar. The mass ratio of the portion of sugar solution to the mixed sugar was 2:1. They were stirred until dissolved, resulting in a newly mixed sugar solution with a mass concentration of 57%. This newly prepared sugar solution was added back into the sugar permeation tank. Gentle agitation was applied to distribute the concentration evenly, achieving a mass concentration of 44% for the sugar solution in the tank. The temperature of the material inside the tank was then lowered to −3° C. Carbon dioxide was charged into the sugar permeation tank, which was then sealed for the second low-temperature sugar permeation, lasting for 15 d.

### (7) Third Low-Temperature Sugar Permeation

A portion of the sugar solution was taken out from the sugar permeation tank (the amount taken was ⅔ of the total mass of the sugar solution in the tank). Newly prepared mixed sugar (malt syrup: granulated sugar=2:8) was added to this portion. No color-protecting agent or firming agent needed to be added to this mixed sugar solution. The mass ratio of the portion of sugar solution to the mixed sugar was 4:3. They were stirred until dissolved, achieving a sugar solution concentration of 63%. The prepared mixed sugar solution was then added back into the sugar permeation tank. Gentle agitation was applied to distribute the concentration evenly, achieving a mass concentration of 56% for the sugar solution in the tank. The temperature of the material inside the tank was lowered to −5° C. Carbon dioxide was charged into the sugar permeation tank, which was then sealed. The third low-temperature sugar permeation lasted for 50 d.

### (8) Drying

The preserved melons were removed from the sugar solution and placed on perforated sieve trays to drain off excess sugar solution. The melon pieces were arranged on baking trays and dried using air flow at 30° C. for 28 h until the moisture content reached 13% to 15%, resulting in cold-impregnated preserved melon.

Although the above examples have described the present disclosure in detail, they are only a part of, not all of, the examples of the present disclosure. Other examples may also be obtained by those skilled in the art based on the examples without creative efforts, and all of these examples shall fall within the protection scope of the present disclosure.

What is claimed is:

1. A processing method for preserved fruits by cold impregnation, comprising following steps:
1) washing and cutting fruits to obtain processed fruits;
2) subjecting the processed fruits to partial dehydration, thereby obtaining partially dehydrated fruits, wherein a mass of the partially dehydrated fruits is 50% to 80% of a mass of the processed fruits before dehydration;
3) immersing the partially dehydrated fruits in a color-protecting and firming mixed sugar solution and conducting a vacuum treatment to obtain vacuum-treated fruits; wherein
the color-protecting and firming mixed sugar solution comprises a mixed sugar solution, a color-protecting agent, and a firming agent, the mixed sugar solution is prepared by mixing mixed sugar and water in a ratio of 1:(1.5-2) and has a sugar content of 30% to 35%; the mixed sugar in the mixed sugar solution comprises malt syrup and granulated sugar, and the malt syrup and the granulated sugar are at a mass ratio of 1:9 to 3:7; a mass of the color-protecting agent is 0.3% to 0.5% of a mass of the mixed sugar solution, and a mass of the firming agent is 0.01% to 0.03% of the mass of the mixed sugar solution;
4) placing the vacuum-treated fruits together with the color-protecting and firming mixed sugar solution into a sugar permeation device to conduct first low-temperature sugar permeation at −2° C. to 0° C., thereby obtaining a mixture of first low-temperature sugar-permeated preserved fruits and the color-protecting and firming mixed sugar solution;
5) supplementing the mixed sugar into the mixture of the first low-temperature sugar-permeated preserved fruits and the color-protecting and firming mixed sugar solution until a mass concentration of the mixed sugar solution in the sugar permeation device reaches 40% to 45%, introducing carbon dioxide into the sugar permeation device, and sealing to conduct second low-temperature sugar permeation at −5° C. to −2° C., thereby obtaining a mixture of second low-temperature sugar-permeated preserved fruits and the color-protecting and firming mixed sugar solution;
6) supplementing the mixed sugar into the mixture of the second low-temperature sugar-permeated preserved fruits and the color-protecting and firming mixed sugar solution until the mass concentration of the mixed sugar solution in the sugar permeation device reaches 55% to 60%, introducing carbon dioxide into the sugar permeation device, and sealing to conduct third low-temperature sugar permeation at −8° C. to −5° C., thereby obtaining a mixture of third low-temperature sugar-permeated preserved fruits and the color-protecting and firming mixed sugar solution; and
7) taking out the preserved fruits from the mixture of the third low-temperature sugar-permeated preserved fruits and the color-protecting and firming mixed sugar solution, draining off the color-protecting and firming mixed sugar solution, and drying to obtain the preserved fruits after the cold impregnation.

2. The processing method for preserved fruits by cold impregnation according to claim 1, wherein a process of the partial dehydration includes room-temperature air flow dehydration conducted at 15° C. to 35° C. and hot air dehydration conducted at 30° C. to 50° C.

3. The processing method for preserved fruits by cold impregnation according to claim 1, wherein the color-protecting agent comprises phytic acid, ascorbic acid, and citric acid at a mass ratio of 3:3:4; and the firming agent is selected from the group consisting of an organic acid calcium salt and an inorganic calcium salt.

4. The processing method for preserved fruits by cold impregnation according to claim 1, wherein the partially dehydrated fruits and the color-protecting and firming mixed sugar solution are at a mass ratio of 1:1 to 1:2 in the step 3).

5. The processing method for preserved fruits by cold impregnation according to claim 1, wherein the vacuum treatment is conducted under a pressure less than or equal to 15 kPa for 20 min to 30 min in the step 3).

6. The processing method for preserved fruits by cold impregnation according to claim 1, wherein the first low-temperature sugar permeation is conducted for 3 d to 15 d in the step 4).

7. The processing method for preserved fruits by cold impregnation according to claim 1, wherein the second low-temperature sugar permeation is conducted for 5 d to 30 d in the step 5).

8. The processing method for preserved fruits by cold impregnation according to claim 1, wherein the third low-temperature sugar permeation is conducted for 10 d to 300 d in the step 6).

9. The processing method for preserved fruits by cold impregnation according to claim 1, wherein the drying is conducted by air flow drying at 15° C. to 50° C. for 12 h to 36 h in the step 7).

10. The processing method for preserved fruits by cold impregnation according to claim 1, wherein the fruits are one or more selected from the group consisting of apricot, jujube, apple, crabapple, and melon.

11. The processing method for preserved fruits by cold impregnation according to claim 4, wherein the vacuum treatment is conducted under a pressure less than or equal to 15 kPa for 20 min to 30 min in the step 3).
